(19) United States
(12) Patent Application Publication
(10) Pub. No.: US 2009/0246437 A1
(43) Pub. Date: Oct. 1, 2009

(54) Laminate Sheet and Manufacturing Method Thereof

(76) Inventor: Do Kyun Lim, Seoul (KR)

Correspondence Address: Jeff Lloyd;Saliwanchik, Lloyd & Saliwanchik, P.O. Box 142950, Gainesville, FL, 32614-2950, US

(21) Appl. No.: 12/060,305

(22) Filed: Apr. 1, 2008

(51) Int. Cl. B32B 33/00; B32B 37/12

(52) U.S. Cl. 428/41.8; 156/289

(57) ABSTRACT

Provided is a method for manufacturing an adhesive laminate sheet. In the method, a stacked sheet in which a film, a release characteristic layer on the film, an adhesive layer on the release characteristic layer, and a base film on the adhesive layer are stacked is formed. An aging process is performed on the stacked sheet. The release characteristic layer and the film separated from the stacked sheet. A release sheet is attached on the adhesive layer of the stacked sheet from which the release characteristic layer and the film have been separated.

### BACKGROUND

The present embodiments relate to an adhesive laminate sheet and a manufacturing method thereof

The adhesive laminate sheet can be used for a decoration purpose or for semi-permanently protecting object goods on which the adhesive laminate sheet is attached.

For example, paper can be prevented from being easily damaged by moisture or impact by attaching the adhesive laminate sheet to the paper.

Meanwhile, in the case of separating the adhesive laminate sheet from paper to reposition the paper after attaching the adhesive laminate sheet on the paper, the paper and/or the adhesive laminate sheet is damaged.

Therefore, when a user intends to attach the adhesive laminate sheet, the user should attach the adhesive laminate sheet initially at an accurate position. When the user cannot attach the adhesive laminate sheet initially at the accurate position, the paper and/or the adhesive laminate sheet cannot be reused.

### BRIEF SUMMARY

Embodiments provide an adhesive laminate sheet and a manufacturing method thereof.

Embodiments also provide an adhesive laminate sheet whose position can be reset without damaging the adhesive laminate sheet and/or object goods to be attached, and a manufacturing method thereof.

Embodiments also provide an adhesive laminate sheet that can prevent performance deterioration of an adhesive caused by migration by not performing a silicon release process, and a manufacturing method thereof.

In one embodiment, an adhesive laminate sheet includes: a base film; an adhesive layer on the base film; and a release sheet attached on the adhesive layer, a pattern being formed in a surface of the release sheet attached on the adhesive layer.

In another embodiment, a method for manufacturing an adhesive laminate sheet includes: forming a stacked sheet in which a film, a release characteristic layer on the film, an adhesive layer on the release characteristic layer, and a base film on the adhesive layer are stacked; performing an aging process on the stacked sheet; separating the release characteristic layer and the film from the stacked sheet; and attaching a release sheet on the adhesive layer of the stacked sheet from which the release characteristic layer and the film have been separated.

In further another embodiment, an adhesive laminate sheet includes: a first base film; a second base film whose one side is attached on the first base film; an adhesive layer on the second base film; and a release sheet attached on the adhesive layer, a pattern being formed in a surface of the release sheet attached on the adhesive layer.

The details of one or more embodiments are set forth in the accompanying drawings and the description below. Other features will be apparent from the description and drawings, and from the claims.

### BRIEF DESCRIPTION OF THE DRAWINGS

FIGS. 1 and 2 are views explaining an adhesive laminate sheet according to an embodiment.

FIGS. 3 to 6 are views explaining a method for manufacturing an adhesive laminate sheet and the characteristic of the adhesive laminate sheet.

### DETAILED DESCRIPTION

Reference will now be made in detail to the embodiments of the present disclosure, examples of which are illustrated in the accompanying drawings.

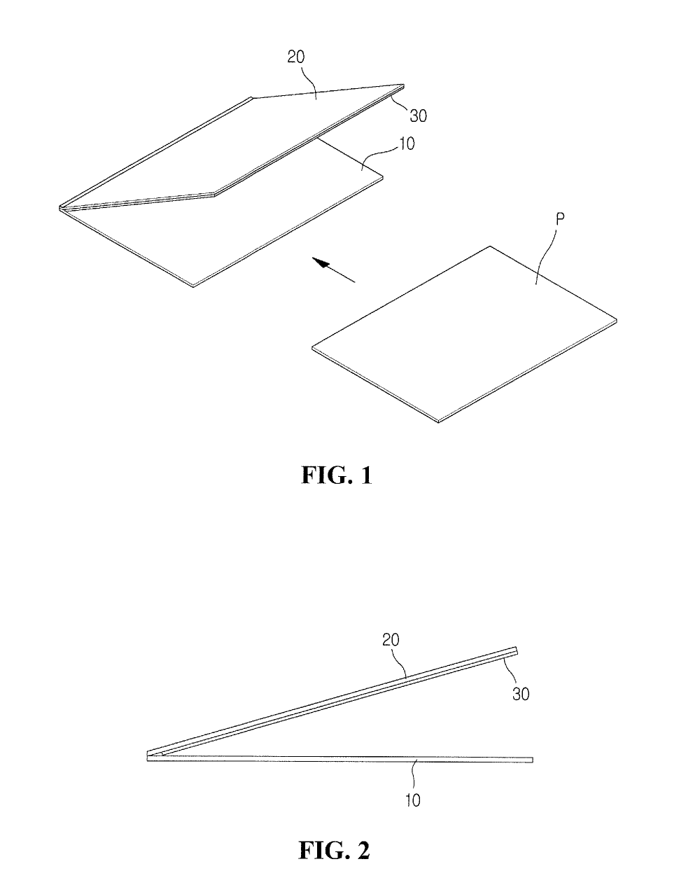

FIGS. 1 and 2 are views explaining an adhesive laminate sheet according to an embodiment.

Though the adhesive laminate sheet can be used in various shapes for various goods, the adhesive laminate sheet according to the embodiments is used for preventing paper from being damaged or spoilt, or protecting the paper from moisture. However, the embodiments are not intended for limiting the scope or application field of the present disclosure but provided for easy understanding of the present disclosure.

Referring to FIGS. 1 and 2, the adhesive laminate sheet includes a first base film 10 and a second base film 20. An adhesive layer (not shown) coated with an adhesive material is formed on the second base film 20. A release sheet 30 having a fine pattern structure is attached on the adhesive layer.

The first base film 10 and the second base film 20 are formed with their one sides attached to each other. After paper P is disposed between the first base film 10 and the second base film 20, the paper P and the first base film 10 are attached on the second base film 20 while the release sheet 30 is removed.

The adhesive laminate sheet according to the embodiment transfers the fine pattern stricture onto the surface of the adhesive layer using the release sheet 30 having the fine pattern structure, so that the adhesive layer has a semi-adhesive characteristic allowing the adhesive layer to be repositioned at an initial adhesion stage and has a strong adhesive characteristic as time elapses after the adhesive layer is attached.

Therefore, when the second base film 20 is attached on the paper P and the first base film 10 after the release sheet 30 is removed, the damage of the second base film 20 including the paper and/or the adhesive layer is small even when the second base film 20 and the paper P are separated from each other at an initial adhesion stage to reposition the paper P and then the second base film 20 and the paper P are attached again.

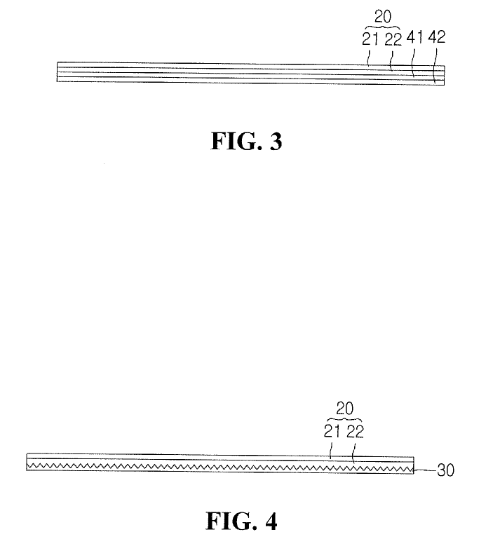

Hereinafter, an adhesive laminate sheet according to an embodiment will be described in more detail with reference to FIGS. 3 to 6.

FIGS. 3 to 6 are views explaining a method for manufacturing an adhesive laminate sheet and the characteristic of the adhesive laminate sheet.

Referring to FIG. 3, a second base film 20 includes a second base film layer 21 and an adhesive layer 22, and is attached on a film 42 on which a release characteristic layer 41 is formed.

That is, after the release characteristic layer 41 is formed on the film 42, the adhesive layer 22 is formed on the release characteristic layer 41 using an adhesion coating equipment. Also, the second base film layer 21 is attached on the adhesive layer 22.

For example, the film 42 can be formed of at least one of a polyethylene terephthalate (PET) film, a poly vinyl chloride (PVC) film, a poly propylene (PP) film, and paper. The film 42 can be formed to have a thickness of 150-300 μm.

Also, the release characteristic layer 41 can be formed of at least one of a rubber-based coating agent, a wax-based coating agent, an urethane-based coating agent, and a polyamide-based coating agent. The release characteristic layer 41 can be formed to have a thickness of 0.5-2 μm.

Also, the adhesive layer 22 can be formed of at least one of an acryl-based adhesive, a rubber-based adhesive, an urethane-based adhesive, and a polyester-based adhesive. The adhesive layer 22 can be formed to have a thickness of 15-30 μm.

Also, the second base film layer 21 can be formed of at least one of a PET film, a PVC film, and a PP film. The second base film layer 21 can be formed of a PVC film having high transparency to have a thickness of 50-100 μm.

An aging process is performed with the second base film layer 21, the adhesive layer 22, the release characteristic layer 41, and the film 42 stacked as illustrated in FIG. 3. The aging process can be performed by leaving the stacked layer at the temperature range of 40-60° C. for 24-48 hours.

The aging process is for stabilizing the characteristic of the adhesive layer 22. The aging process allows the adhesive force of the adhesive layer 22 to be uniform through volatilization of a residual solvent included in the adhesive layer 22 and chemical stabilization of a residual polymer.

Referring to FIG. 4, after the aging process is performed, the film 42 on which the release characteristic film 41 has been formed is removed. Then, a releasing sheet 30 having a fine pattern structure is attached to the adhesive layer 22.

The releasing sheet 30 has a fine pattern structure in a direction in which the releasing sheet 30 is attached. The releasing sheet 30 can be formed of at least one of a PVC film, a PE film, and paper to have a thickness of 100-200 μm.

Therefore, a second base film 20 on which the releasing sheet 30 has been attached is manufactured as illustrated in FIGS. 1 and 2.

In a related art adhesive laminate sheet, a silicon release process has been performed on a releasing sheet for protecting an adhesive layer. In the case where the silicon release process is performed on the release sheet, not only costs increase in an aspect of process, but also performance deterioration of the adhesive layer may be generated due to silicon migration when the silicon-release processed release sheet attached on the adhesive layer is stored for a long time.

Meanwhile, since the adhesive layer 22 is stabilized through the aging process in the adhesive laminate sheet according to the embodiment, a separate silicon release process does not need to be performed on the release sheet 30 and thus the performance deterioration is not generated.

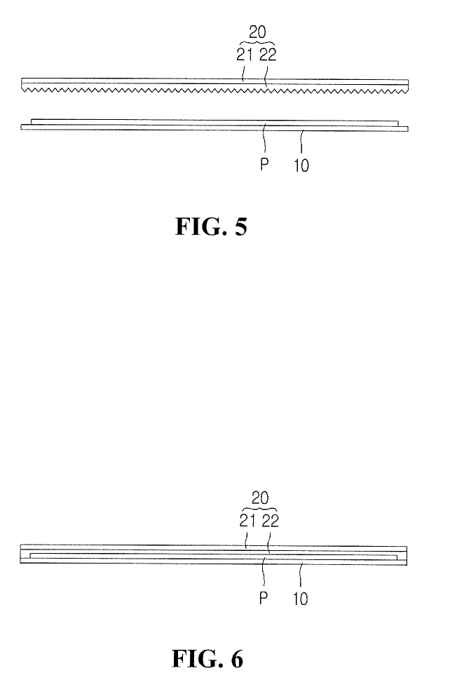

Referring to FIG. 5, when paper P is disposed on the first base film 10, and the release sheet 30 attached on the second base film 20 is removed, the fine pattern structure formed in the release sheet 30 is transferred to the adhesive layer 22 of the second base film 20.

Therefore, when the first base film 10, the paper P, and the second base film 20 are attached, a semi-adhesive characteristic allowing repositioning through the Fine pattern structure is achieved.

However, referring to FIG. 6, when a time elapses after the first base film 10, the paper P, and the second base film 20 are attached, a resin flow phenomenon is generated to the adhesive layer 22 and an adhesive area increases, so that a strong adhesive characteristic is achieved.

That is, when the release sheet 30 is removed, an uneven fine pattern structure is transferred to the adhesive layer 22. At an initial adhesive stage, the protrusion portion of the fine pattern structure of the adhesive layer 22 contacts the surface of the paper P to provide the semi-adhesive characteristic. However, when a predetermined time elapses, the protrusion portion of the fine pattern structure of the adhesive layer 22 gets flat due to the resin flow phenomenon as illustrated in FIG. 6, so that the adhesive area increases to provide a strong adhesive characteristic.

Also, the fine pattern structure of the adhesive layer 22 allows air to easily flow during a laminating operation to effectively remove limitations such as a bubble and an air pocket that may occur during the laminating operation.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An adhesive laminate sheet comprising:
a base film;
an adhesive layer on the base film; and
a release sheet attached on the adhesive layer, a pattern being formed in a surface of the release sheet attached on the adhesive layer.

2. The adhesive laminate sheet according to claim 1, wherein the release sheet is not silicon release-processed.

3. The adhesive laminate sheet according to claim 1, wherein the base film comprises at lease one of a polyethylene terephthalate film, a poly vinyl chloride film, and a poly propylene film.

4. The adhesive laminate sheet according to claim 1, wherein the adhesive layer comprises at least one of an acryl-based adhesive, a rubber-based adhesive, an urethane-based adhesive, and a polyester-based adhesive.

5. The adhesive laminate sheet according to claim 1, wherein the release sheet comprises at lease one of a poly vinyl chloride film, a polyethylene film, and paper.

6. A method for manufacturing an adhesive laminate sheet, the method comprising:
forming a stacked sheet in which a film, a release characteristic layer on the film, an adhesive layer on the release characteristic layer, and a base film on the adhesive layer are stacked;
performing an aging process on the stacked sheet;
separating the release characteristic layer and the film from the stacked sheet; and
attaching a release sheet on the adhesive layer of the stacked sheet from which the release characteristic layer and the film have been separated.

7. The method according to claim 6, wherein the forming of the stacked sheet comprises:
forming the release characteristic layer on the film;
forming the adhesive layer on the release characteristic layer; and
attaching the base film on the adhesive layer.

8. The method according to claim 6, wherein the aging process is performed at a temperature range of 40-60° C. for 24-48 hours.

9. The method according to claim 6, wherein the release sheet is not silicon release-processed.

10. The method according to claim 6, wherein the base film comprises at least one of a polyethylene terephthalate film, a poly vinyl chloride film, and a poly propylene film.

11. The method according to claim 6, wherein the adhesive layer comprises at least one of an acryl-based adhesive, a rubber-based adhesive, an urethane-based adhesive, and a polyester-based adhesive.

12. The method according to claim 6, wherein the release sheet comprises at lease one of a poly vinyl chloride film, a polyethylene film, and paper.

13. The method according to claim 6, wherein the film comprises at leases one of a polyethylene terephthalate film, a poly vinyl chloride film, a poly propylene film, and paper.

14. The method according to claim 6, wherein the release characteristic layer is formed of at least one of a rubber-based coating agent, a wax-based coating agent, an urethane-based coating agent, and a polyamide-based coating agent.

15. An adhesive laminate sheet comprising:
a first base film;
a second base film whose one side is attached on the first base film;
an adhesive layer on the second base film; and
a release sheet attached on the adhesive layer, a pattern being formed in a surface of the release sheet attached on the adhesive layer.

16. The adhesive laminate sheet according to claim 15, wherein the release sheet is not silicon release-processed.

17. The adhesive laminate sheet according to claim 15, wherein the second base film comprises at lease one of a polyethylene terephthalate film, a poly vinyl chloride film, and a poly propylene film.

18. The adhesive laminate sheet according to claim 15, wherein the adhesive layer comprises at least one of an acryl-based adhesive, a rubber-based adhesive, an urethane-based adhesive, and a polyester-based adhesive.

19. The adhesive laminate sheet according to claim 15, wherein the release sheet comprises at lease one of a poly vinyl chloride film, a polyethylene film, and paper.
